(19) United States
(12) Patent Application Publication
(10) Pub. No.: US 2026/0149205 A1
(43) Pub. Date: May 28, 2026

(54) WIRE-TO-BOARD CONNECTOR ASSEMBLY AND ITS WIRE-END CONNECTOR AND BOARD-END CONNECTOR

(71) Applicant: Bellwether Electronic Corp., Taoyuan City (TW)

(72) Inventor: Shih-Yang HONG, Taoyuan City (TW)

(21) Appl. No.: 19/336,447

(22) Filed: Sep. 22, 2025

Related U.S. Application Data
(60) Provisional application No. 63/724,421, filed on Nov. 25, 2024.

(30) Foreign Application Priority Data
Aug. 15, 2025 (TW) 114131301

(51) Int. Cl. H01R 12/75; H01R 12/71; H01R 13/627

(52) U.S. Cl. CPC H01R 12/75; H01R 12/716; H01R 13/6272

(57) ABSTRACT

A wire-to-board connector assembly includes a wire-end connector and a board-end connector. The wire-end connector includes a first housing and a first terminal disposed within the first housing. The first terminal includes a first main plate and a plurality of wire coupling portions connected to the first main plate. The wire coupling portions are configured to connect to at least one wire. The board-end connector configured to be use with the wire-end connector. The board-end connector includes a second housing and a second terminal disposed within the second housing. The second terminal includes a second main plate and a plurality of pins connected to the second main plate. The pins are configured to plug into a circuit board.

### CROSS - REFERENCE TO RELATED APPLICATION

This application claims priority to U.S. Provisional Application Serial Number 63/724,421 filed November 25, 2024, and Taiwan Application Serial Number 114131301, filed August 15, 2025, the disclosures of which are incorporated herein by reference in their entireties.

### BACKGROUND

### FIELD OF INVENTION

The present invention relates to a wire-to-board connector assembly, including its wire-end connector and board-end connector. More particularly, the present invention relates to a wire-to-board connector assembly, and its wire-end connector and board-end connector, which are configured to increase the conductive cross-sectional area.

### DESCRIPTION OF RELATED ART

In recent times, wire-to-board connector assemblies, along with their wire-end connectors and board-end connectors, have been widely used in automotive, industrial automation, home appliances, consumer electronics, medical equipment, energy or battery systems, aerospace, and military applications.

However, with the rapid development of these fields, the power demand of electronic products has also increased, resulting in the current supply of wire-to-board connector assemblies gradually becoming insufficient.

Accordingly, providing a wire-to-board connector assembly, together with its wire-end connector and board-end connector, to address the aforementioned problems has become an important issue for those in the industry.

### SUMMARY

An aspect of the disclosure is to provide a wire-to-board connector assembly, including its wire-end connector and board-end connector, which can efficiently address the aforementioned problems.

According to an embodiment of the disclosure, a wire-end connector includes a first housing and a first terminal. The first terminal is disposed in the first housing and includes a first main plate and a plurality of wire coupling portions connected thereto. The wire coupling portions are configured to connect at least one wire.

In an embodiment of the disclosure, the first terminal further includes a bending portion, an extension portion, and a contact portion. The bending portion is connected to the extension portion. The bending portion bends substantially perpendicularly from two opposite sides of the first main plate. The extension portion extends toward each other substantially parallel to the first main plate. The contact portion is a clip structure.

In an embodiment of the disclosure, the first housing further includes an opening portion and a receiving portion. The opening portion and the receiving portion are connected to each other. The receiving portion has a plurality of connection ports. Each connection port includes two long plates and two short plates. A length of the two long plates is greater than a length of the two short plates. A length ratio of one of the long plates to one of the short plates is greater than 1.5.

In an embodiment of the disclosure, the first housing includes a first accommodating channel. The first terminal is disposed in the first accommodating channel. The first accommodating channel has a cross-sectional profile that is substantially rectangular.

In an embodiment of the disclosure, the first terminal further includes two latches and a stop pin. The first housing further includes a stop surface, two sliding grooves, and a stop rib. The two sliding grooves and the stop rib are disposed in the first accommodating channel. The two latches are configured to slide into the two sliding grooves and be clamped on both sides of the stop rib. The stop pin abuts against the stop surface.

According to an embodiment of the disclosure, a board-end connector specifically configured for use with a wire-end connector includes a second housing and a second terminal. The second terminal is disposed in the second housing and includes a second main plate and a plurality of pins connected thereto. The pins are configured to plug into a circuit board.

In an embodiment of the disclosure, the second housing includes a second accommodating channel. The second terminal is disposed in the second accommodating channel. The second accommodating channel has a cross-sectional profile that is substantially rectangular. A ratio of length to width of the cross-sectional profile is greater than 1.5.

According to an embodiment of the disclosure, a wire-to-board connector assembly includes a wire-end connector and a board-end connector. The wire-end connector includes a first housing and a first terminal. The first terminal is disposed in the first housing and includes a first main plate and a plurality of wire coupling portions connected thereto. The wire coupling portions are configured to connect at least one wire. The board-end connector includes a second housing and a second terminal. The second housing is detachably connected to the first housing. The second terminal is disposed in the second housing and engages with the first terminal. The second terminal includes a second main plate and a plurality of pins connected thereto. The pins are configured to plug into a circuit board. The first terminal further includes a bending portion, an extension portion, a first clip, and a second clip. The bending portion is connected to the extension portion. The bending portion bends substantially perpendicularly from two opposite sides of the first main plate. The extension portion extends substantially parallel to the first main plate and toward each other. The first clip extends from the first main plate toward the second terminal. The second clip extends from the extension portion toward the second terminal. The first clip and the second clip jointly clamp the second main plate of the second terminal.

In an embodiment of the disclosure, the first housing includes a first accommodating channel. The first terminal is disposed in the first accommodating channel. The first accommodating channel has a cross-sectional profile. The cross-sectional profile is substantially rectangular.

In an embodiment of the disclosure, the second housing includes a second accommodating channel. The second terminal is disposed in the second accommodating channel. The second accommodating channel has a cross-sectional profile that is substantially rectangular. A ratio of length to width of the cross-sectional profile of the second accommodating channel is greater than 1.5.

In an embodiment of the disclosure, the first housing further includes an opening portion and a receiving portion. The opening portion and the receiving portion are connected to each other. The receiving portion is disposed in the second accommodating channel.

In an embodiment of the disclosure, the receiving portion has a plurality of connection ports. Each connection port includes two long plates and two short plates. A length of the two long plates is greater than a length of the two short plates. A length ratio of one of the long plates to one of the short plates is greater than 1.5.

In an embodiment of the disclosure, the bending portion of the first terminal is adjacent to an inner surface of one of the two short plates of the receiving portion. The extension portion of the first terminal is adjacent to an inner surface of one of the long plates of the receiving portion.

In an embodiment of the disclosure, the wire-to-board connector assembly further includes a third terminal and a fourth terminal. The third terminal is disposed in the first housing. The fourth terminal is disposed in the second housing. The third terminal is electrically connected to the fourth terminal.

In an embodiment of the disclosure, the first housing includes a third accommodating channel and the second housing includes a fourth accommodating channel. The third terminal is disposed in the third accommodating channel, and the fourth terminal is disposed in the fourth accommodating channel. The third accommodating channel and the fourth accommodating channel are interconnected.

Accordingly, in the wire-to-board connector assembly and its wire-end connector and board-end connector of the present disclosure, by electrically connecting the plurality of wire coupling portions to the first main plate, the conductive cross-sectional area of the first terminal can be increased to carry a larger current. By configuring the accommodating channels of the first housing and the second housing as rectangular spaces, the flat first main plate and the flat second main plate can be accommodated, thereby increasing the conductive cross-sectional area and reducing resistance. By designing the contact portion where the first terminal engages the second terminal as a clip structure, the first terminal and the second terminal can be easily plugged in and out, while also preventing loosening or poor contact due to slight gap changes caused by factors such as thermal expansion, vibration, or wear during the electrical connection process. In this way, the contact portion is compatible with second main plates of different thicknesses or widths.

It is to be understood that both the foregoing general description and the following detailed description are provided by way of example, and are intended to further explain the invention as claimed.

### BRIEF DESCRIPTION OF THE DRAWINGS

The invention can be more fully understood by reading the following detailed description of the embodiments, with reference to the accompanying drawings as follows:

FIG. 1 is a rear perspective view of a wire-to-board connector assembly according to an embodiment of the present disclosure;

FIG. 2 is a front perspective view of the wire-to-board connector assembly in FIG. 1;

FIG. 3 is a side perspective view of the wire-to-board connector assembly in FIG. 1 before a first terminal is engaged with a second terminal;

FIG. 4 is a rear perspective view of the wire-end connector and the board-end connector of FIG. 1 after being separated;

FIG. 5 is a front perspective view of the wire-end connector of FIG. 4;

FIG. 6 is a cross-sectional view of the wire-to-board connector assembly of FIG. 1, taken along section line A-A;

FIG. 7 is a cross-sectional view of the wire-to-board connector assembly of FIG. 1, taken along section line B-B;

FIG. 8 is a perspective view of the wire-to-board connector assembly of FIG. 1 before a third terminal is engaged with a fourth terminal;

FIG. 9 is a perspective view of the wire-to-board connector assembly of FIG. 1 according to another embodiment of the present disclosure;

FIG. 10 is a perspective view of a wire-to-board connector assembly of FIG. 9 before a first terminal is engaged with a second terminal;

FIG. 11 is a perspective view of the wire-to-board connector assembly of FIG. 1 according to another embodiment of the present disclosure; and

FIG. 12 is a perspective view of a wire-to-board connector assembly of FIG. 11 before a first terminal is engaged with a second terminal.

### DETAILED DESCRIPTION

Reference will now be made in detail to the present embodiments of the invention, examples of which are illustrated in the accompanying drawings. Wherever possible, the same reference numbers are used in the drawings and the description to refer to the same or similar parts. However, specific structural and functional details disclosed herein are merely representative for purposes of describing example embodiments, and may be embodied in many alternate forms. They should not be construed as limited to only example embodiments set forth herein. Therefore, it should be understood that there is no intent to limit the example embodiments to the particular forms disclosed. On the contrary, the example embodiments are intended to cover all modifications, equivalents, and alternatives falling within the scope of the invention.

To help readers clearly understand the coordination and orientation of the various components, the drawings indicate coordinate axes X, Y and Z. The X-axis represents a first direction, the Y-axis represents a second direction, and the Z-axis represents a third direction. Furthermore, the first direction X, the second direction Y, and the third direction Z are perpendicular to each other.

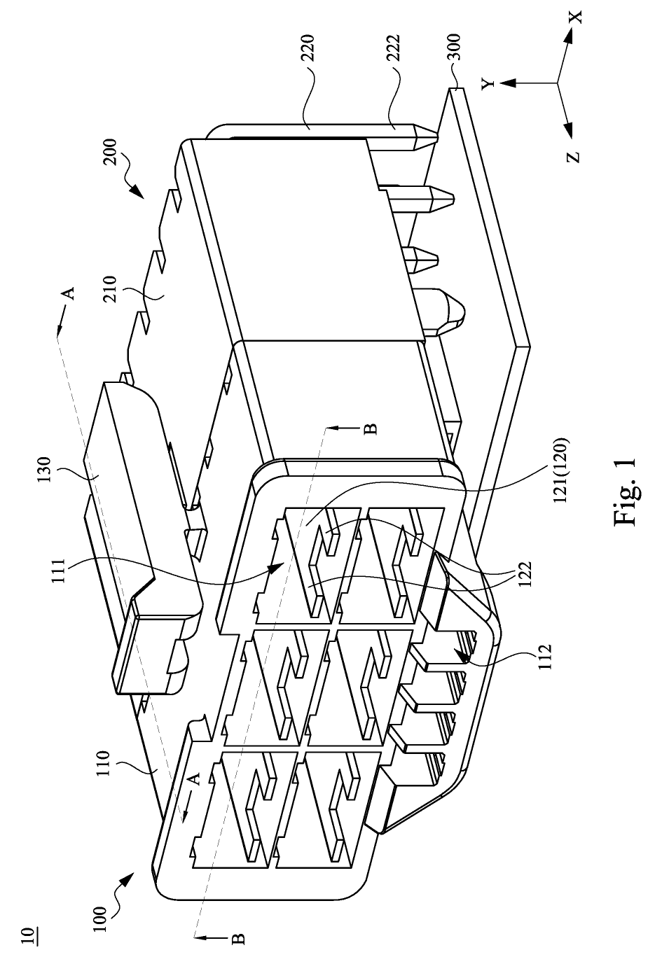

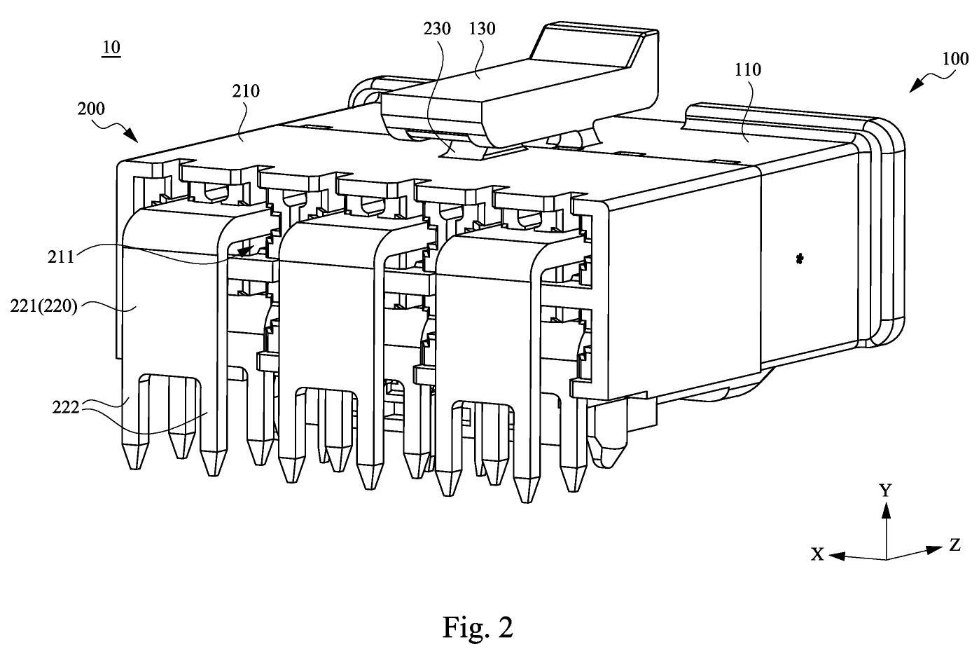

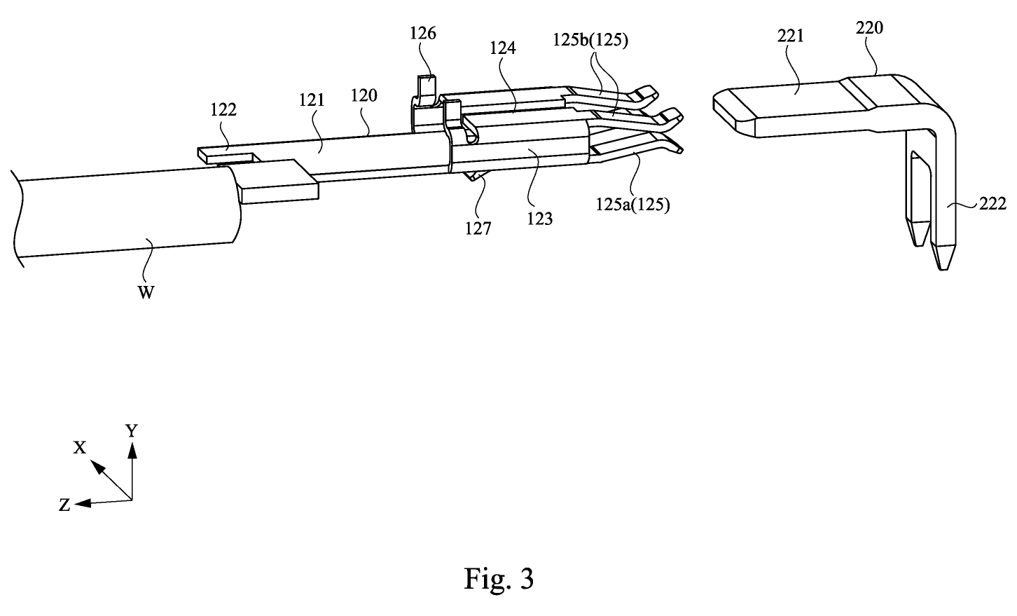

Please refer to FIG. 1 and FIG. 2. FIG. 1 is a rear perspective view of a wire-to-board connector assembly 10 according to an embodiment of the present disclosure. FIG. 2 is a front perspective view of the wire-to-board connector assembly 10 of FIG. 1. As shown in FIG. 1 and FIG. 2, in the present embodiment, the wire-to-board connector assembly 10 includes a wire-end connector 100 and a board-end connector 200. The wire-end connector 100 can be connected to a wire W (see FIG. 3), and the board-end connector 200 can be connected to a circuit board 300. In the present embodiment, the wire-end connector 100 includes a first housing 110 and a first terminal 120. The first housing 110 includes a first accommodating channel 111, and the first terminal 120 is disposed in the first accommodating channel 111 of the first housing 110. The board-end connector 200 includes a second housing 210 and a second terminal 220. The second housing 210 includes a second accommodating channel 211, and the second terminal 220 is disposed in the second accommodating channel 211 of the second housing 210.

As shown in FIG. 1 and FIG. 2, in the present embodiment, the first housing 110 is detachably engaged with the second housing 210. Specifically, the first housing 110 includes a depressible latch 130, and the second housing 210 includes a rib 230. The latch 130 can be engaged with the rib 230 to secure the first housing 110 to the second housing 210. Since the board-end connector 200 is typically fixed to the circuit board 300, during assembly or disassembly, the latch 130 can be pressed away from the rib 230, allowing the first housing 110 to be removed along the third direction Z to separate the first housing 110 from the second housing 210. Alternatively, the first housing 110 can be inserted into the second housing 210 in a direction opposite to the third direction Z to achieve engagement. In the present embodiment, the engaging surfaces of the first housing 110 and the second housing 210 are coplanar after engagement, although the present disclosure is not limited in this regard.

Please refer to FIG. 3. FIG. 3 is a side perspective view of the wire-to-board connector assembly 10 of FIG. 1 before the first terminal 120 is engaged with the second terminal 220. As shown in FIG. 3, in the present embodiment, the first terminal 120 can be engaged with the second terminal 220. The first terminal 120 includes a first main plate 121 and a plurality of wire coupling portions 122 connected to the first main plate 121. The second terminal 220 includes a second main plate 221 and a plurality of pins 222 connected to the second main plate 221. Specifically, each wire coupling portion 122 of the first terminal 120 can be crimped or soldered to the wire W to receive electricity. The first main plate 121 can be electrically connected (similar to a current-conducting bridge) to the wire coupling portions 122 connected thereto, thereby increasing the conductive cross-sectional area, reducing contact resistance, increasing current capacity, simplifying the structure, and improving stability. In the present embodiment, the first main plate 121 is formed from a single-piece copper sheet, but the present disclosure is not limited in this regard. The first main plate 121 may also be made of any metal or non-metal material with good electrical conductivity. In the present embodiment, the second main plate 221 has substantially the same structure and conductive properties as the first main plate 121. The difference is that the second main plate 221 is electrically connected to the pins 222, which are inserted into the circuit board 300 (see FIG. 1). The second main plate 221 is configured to receive electricity from the first terminal 120 and supply power to the circuit board 300 through the pins 222.

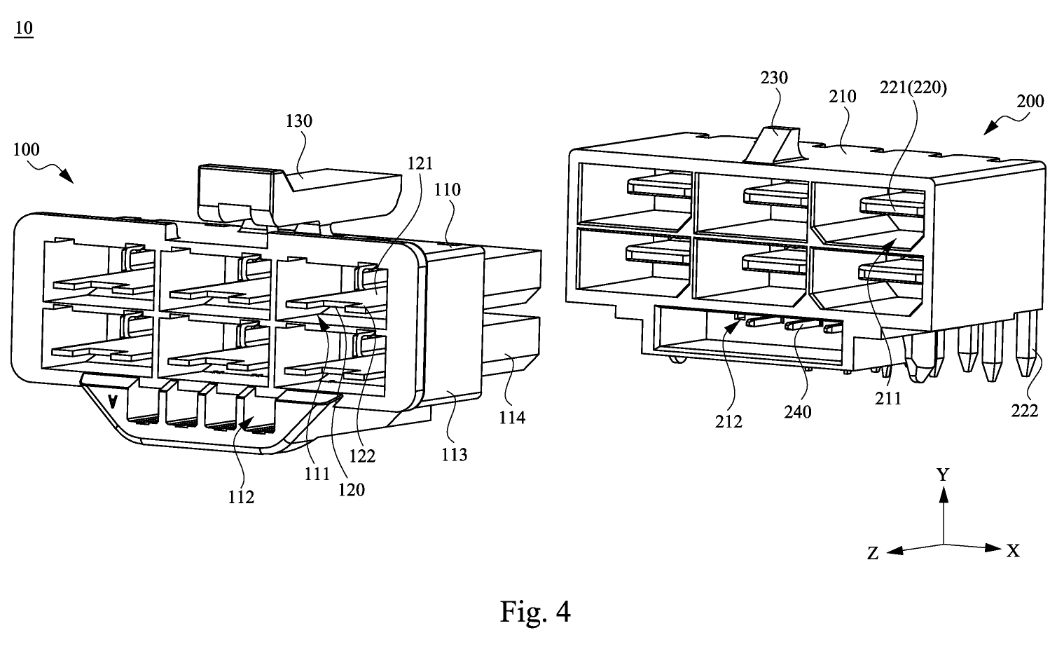

Please refer to FIG. 4, which is a rear perspective view of the wire-end connector 100 and the board-end connector 200 of FIG. 1 after separation. As shown in FIG. 4, in the present embodiment, the first housing 110 includes an opening portion 113 and a receiving portion 114, which are interconnected. Specifically, when the first housing 110 is engaged with the second housing 210, the opening portion 113 remains exposed, while the receiving portion 114 is inserted into and enclosed within the second accommodating channel 211 of the second housing 210. At this stage, the second terminal 220 partially enters the receiving portion 114 of the first housing 110 and engages with the first terminal 120. In other words, the first accommodating channel 111 constitutes an accommodation space formed by the interiors of the opening portion 113 and the receiving portion 114, and the first terminal 120 is located within both the opening portion 113 and the receiving portion 114. More specifically, the wire coupling portions 122 of the first terminal 120 are disposed within the opening portion 113. When the first housing 110 is engaged with the second housing 210, the section of the first terminal 120 within the receiving portion 114 is simultaneously received in the second accommodating channel 211 of the second housing 210 and engages with the second terminal 220. In the present embodiment, when the first housing 110 and the second housing 210 are engaged, the first accommodating channel 111 and the second accommodating channel 211 are connected to each other, thereby achieving electrical connection between the first terminal 120 and the second terminal 220.

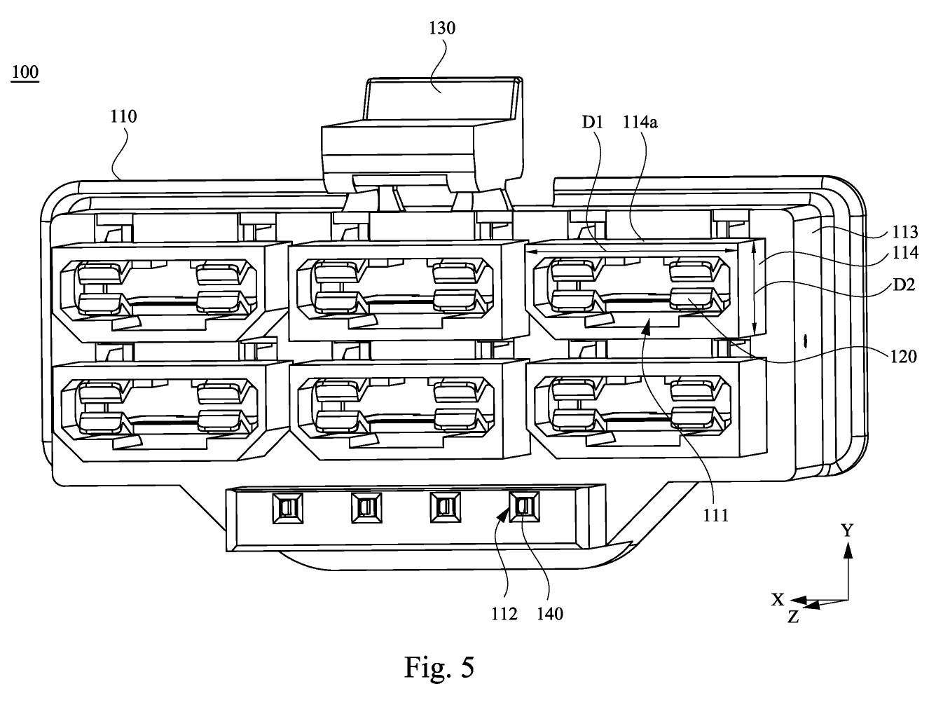

Please refer to FIG. 5, which is a front perspective view of the wire-end connector 100 shown in FIG. 4. As shown in FIG. 5, and with reference also to FIGS. 1 and 3, in the present embodiment, when the first housing 110 is viewed along the third direction Z and in the direction opposite to Z, the first accommodating channel 111 exhibits a cross-sectional profile that is substantially rectangular in shape. Specifically, since the first main plate 121 of the first terminal 120 is a flat, plate-like structure (e.g., a rectangular copper sheet), it is capable of carrying a larger current. Accordingly, the first accommodating channel 111 is shaped to correspond to the flat structure of the first main plate 121, and thus has a rectangular cross-sectional profile, in contrast to the square profile of the accommodating channel in a conventional wire-end connector. In the present embodiment, the receiving portion 114 of the first housing 110 includes a plurality of connection ports 114a, each of which accommodates the first terminal 120. Each connection port 114a includes two long plates D1 and two short plates D2, with the long plates D1 being longer than the short plates D2. The ratio of the length of the long plates D1 to the length of the short plates D2 is greater than 1.5. In other words, the long plates D1 and short plates D2 of each connection port 114a together define the rectangular cross-sectional profile of the first accommodating channel 111 within the receiving portion 114. Furthermore, the second accommodating channel 211 of the second housing 210 also has a cross-sectional profile. Since the second accommodating channel 211 covers the connection ports 114a of the receiving portion 114 of the first housing 110 (as shown in FIG. 4), its cross-sectional profile is likewise substantially rectangular. Because the ratio of the length of the long plates D1 to the length of the short plates D2 of the connection port 114a is greater than 1.5, the length-to-width ratio of the cross-sectional profile of the second accommodating channel 211 is also greater than 1.5.

As shown in FIG. 3, and with reference to FIG. 5, in the present embodiment, the first terminal 120 further includes a bending portion 123 and an extension portion 124 on the side opposite the wire coupling portions 122. The bending portion 123 extends substantially perpendicularly from two opposite sides of the first main plate 121. In other words, the bending portion 123 projects outward in the second direction Y from two opposite sides of the first main plate 121. The extension portion 124 is connected to the ends of the bending portions 123 away from the first main plate 121, and the extension portions 124 extend toward each other in a direction substantially parallel to the first main plate 121. In other words, the two extension portions 124 extend toward each other from opposite sides of the bending portions 123, approaching along the first direction X and the opposite direction of X, respectively. Accordingly, a substantial distance is maintained between the extension portions 124 and the first main plate 121, enabling the extension portions 124 and the first main plate 121 to abut against two opposing inner surfaces of the first accommodating channel 111 of the receiving portion 114. This configuration secures the first terminal 120 more firmly within the first accommodating channel 111. Specifically, the bending portion 123 is positioned adjacent to the inner surface of the short plate D2 of the receiving portion 114, while the extension portion 124 is positioned adjacent to the inner surface of the long plate D1 of the receiving portion 114.

As shown in FIG. 3, and with reference to FIG. 4, in the present embodiment, the first terminal 120 further includes a contact portion 125 at the end opposite the wire coupling portions 122. The contact portion 125 is configured to establish electrical connection between the first terminal 120 and the second terminal 220. Specifically, the contact portion 125 includes a first clip 125a and a second clip 125b that clamp together. The first clip 125a extends from the first main plate 121 toward the second terminal 220, and the second clip 125b extends from the extension portion 124 toward the second terminal 220. The first clip 125a and the second clip 125b jointly clamp the second main plate 221 of the second terminal 220. The clamping design of the first clip 125a and the second clip 125b facilitates easier plugging and unplugging of the wire-end connector 100 and the board-end connector 200, when preventing loosening or poor contact caused by slight gap variations between the first terminal 120 and the second terminal 220 during electrical connection. Such variations may arise from factors including thermal expansion, vibration, or abrasion. In the present embodiment, the contact portion 125 of the first terminal 120 can form multiple contact points when clamping the second main plate 221 of the second terminal 220, thereby reducing contact resistance and improving conductive reliability. In addition, the clip structure of the contact portion 125 allows compatibility with second main plates 221 of different thicknesses or widths.

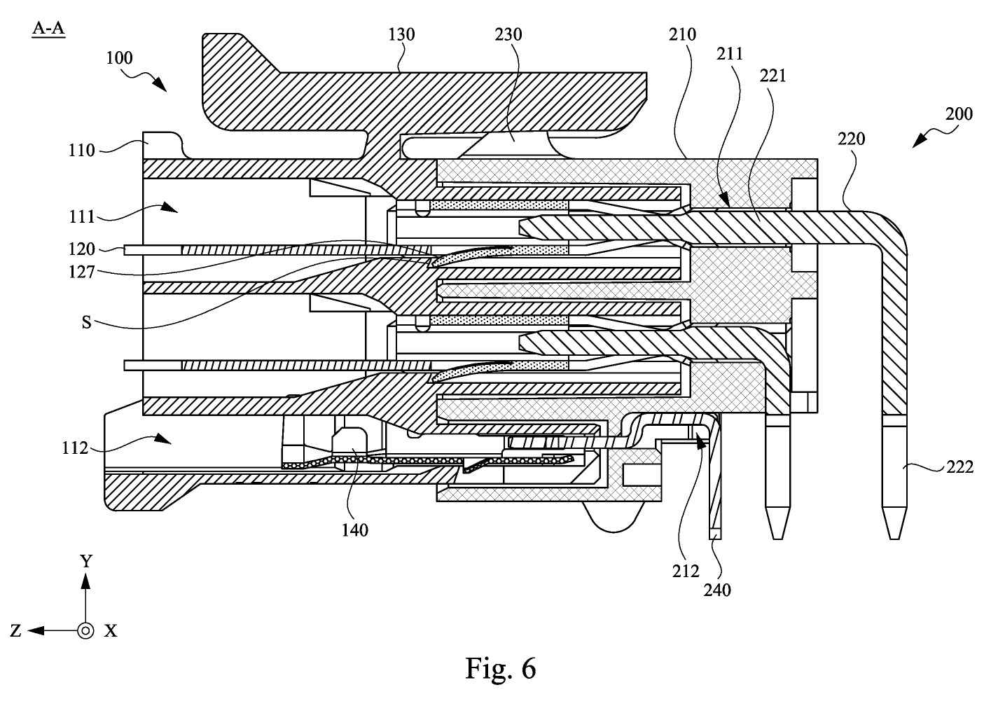

Please refer to FIG. 6, which is a cross-sectional view of the wire-to-board connector assembly 10 of FIG. 1 taken along section line A-A. As shown in FIG. 6, and with reference to FIGS. 3 and 4, in the present embodiment, the first terminal 120 further includes a stop pin 127. The stop pin 127 is disposed on a side of the first main plate 121 opposite the second terminal 220. In addition, the first housing 110 further includes a stop surface S, which is located on an inner surface of the first accommodating channel 111 facing the second terminal 220. Specifically, the stop pin 127 is a spring structure with a rebound force. When the first terminal 120 enters the first accommodating channel 111 of the receiving portion 114 from the first accommodating channel 111 of the opening portion 113, the stop pin 127 is initially pressed by the inner surface of the first accommodating channel 111, causing elastic deformation. Once the first terminal 120 is engaged with the second terminal 220, the stop pin 127 releases the rebound force and abuts against the stop surface S. In this position, the stop pin 127 prevents the first terminal 120 from being withdrawn from the first accommodating channel 111 in the third direction Z, thereby improving the stability of the engagement between the first terminal 120 and the second terminal 220.

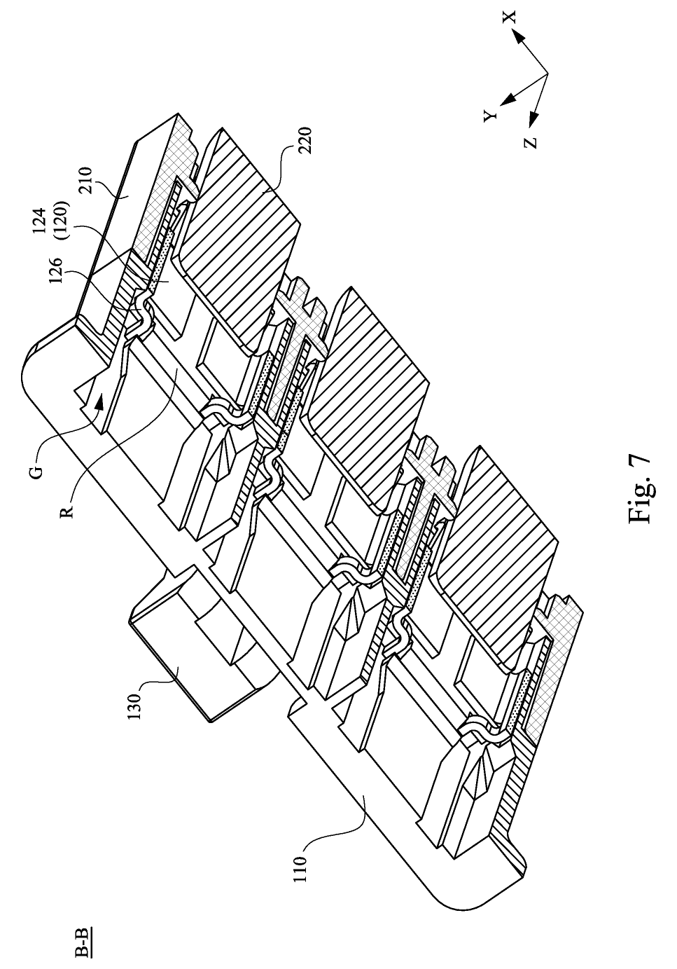

Please refer to FIG. 7, which is a cross-sectional view of the wire-to-board connector assembly 10 of FIG. 1 taken along section line B-B. As shown in FIG. 7, and with reference to FIGS. 3 and 4, in the present embodiment, the first terminal 120 further includes two engaging elements 126. The two engaging elements 126 extend and bend from two opposite sides of the first main plate 121. The first housing 110 further includes two sliding grooves G and a stop rib R disposed within the first accommodating channel 111. The stop rib R is located on one side of the two sliding grooves G, adjacent to the second housing 210 and is configured to be clamped between the two engaging elements 126. During insertion of the first terminal 120 into the first accommodating channel 111 in the direction opposite to the third direction Z, the engaging elements 126 of the first terminal 120 first slide into the channel along the sliding grooves G. Once the engaging elements 126 reach the stop rib R, they push against it and then respectively engage with its opposite sides, thereby securing the first terminal 120 in place. Specifically, the height of the ends of the two engaging elements 126, measured relative to the first main plate 121, is greater than the height of the extension portion 124 relative to the first main plate 121. In other words, the engaging elements 126 are blocked within the first accommodating channel 111 of the opening portion 113 and do not extend into the receiving portion 114 along with the extension portion 124. This configuration prevents the first terminal 120 from escaping from the first accommodating channel 111 in the direction opposite to the third direction Z.

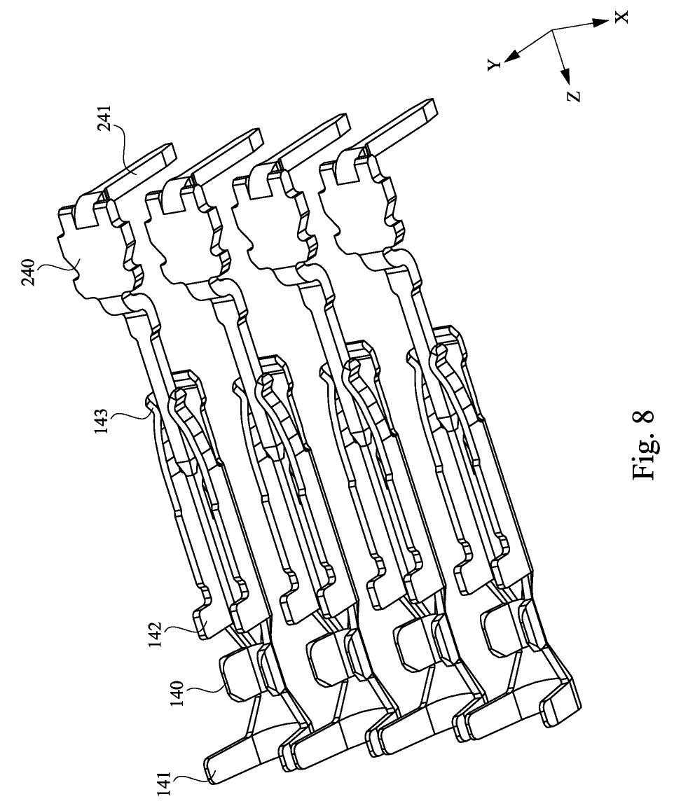

Please refer to FIG. 8, which is a perspective view of the wire-to-board connector assembly 10 of FIG. 1 before the third terminal 140 is engaged with the fourth terminal 240. As shown in FIG. 8, and with reference to FIG. 4, in the present embodiment, the wire-to-board connector assembly 10 further includes a third terminal 140 and a fourth terminal 240, with the third terminal 140 being electrically connected to the fourth terminal 240. The third terminal 140 and the fourth terminal 240 serve as signal terminals configured to perform signal transmission or control. Specifically, after the third terminal 140 is connected to a signal wire (not shown), it transmits a signal when engaged with the fourth terminal 240. The fourth terminal 240 then further transmits the signal to the circuit board 300 through the signal pin 241 (see FIG. 1). In the present embodiment, the first housing 110 further includes a third accommodating channel 112, and the second housing 210 further includes a fourth accommodating channel 212. The third terminal 140 is disposed within the third accommodating channel 112, and the fourth terminal 240 is disposed within the fourth accommodating channel 212. The third accommodating channel 112 and the fourth accommodating channel 212 are interconnected to provide electrical connection between the third terminal 140 and the fourth terminal 240.

As shown in FIG. 8, in the present embodiment, the third terminal 140 includes a crimping portion 141, a fixing element 142, and a clamping element 143. The crimping portion 141 secures the signal wire (not shown) to the third terminal 140 through crimping, but the present disclosure is not limited to this method. The crimping portion 141 may alternatively secure the signal wire through soldering or other suitable fixing methods. The fixing element 142 maintains the signal wire in a fixed position to ensure that stable contact with the third terminal 140. The clamping element 143 ensures that the third terminal 140 engages with the fourth terminal 240 and maintains stable contact between them, thereby improving the quality and reliability of signal transmission.

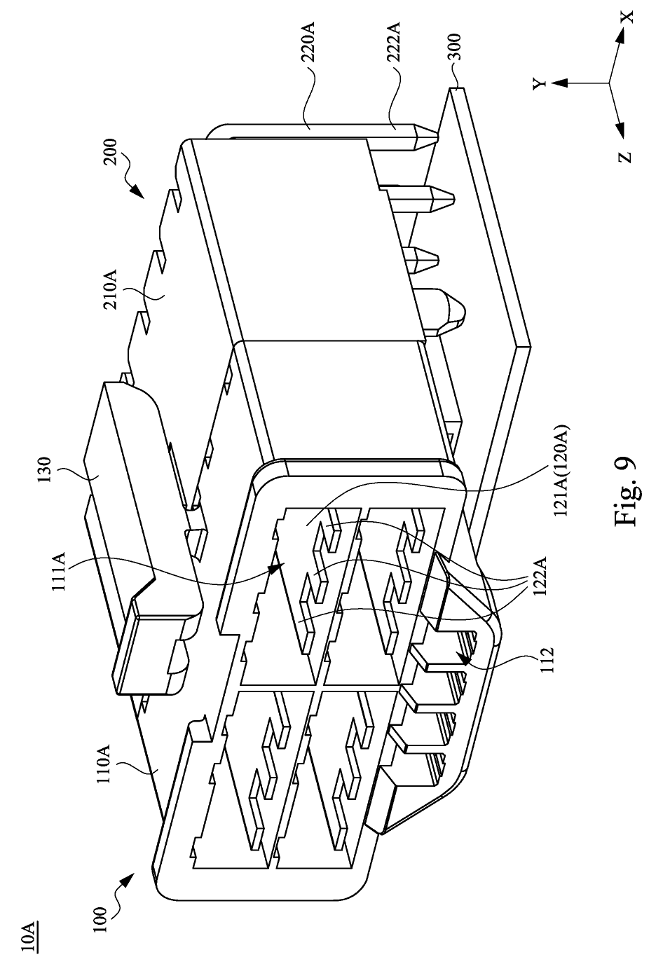

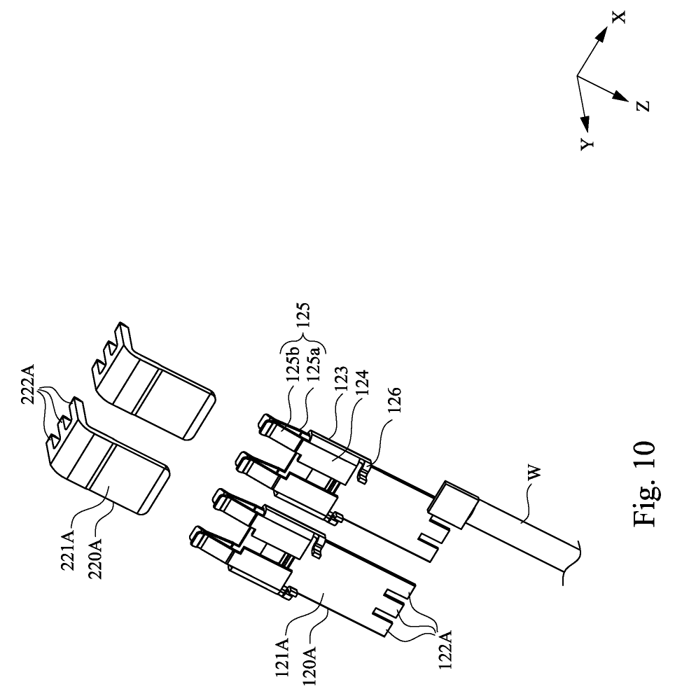

Please refer to FIGS. 9 and 10. FIG. 9 is a perspective view of the wire-to-board connector assembly 10 of FIG. 1 according to another embodiment of the present disclosure. FIG. 10 is a perspective view of a wire-to-board connector assembly 10A of FIG. 9 before a first terminal 120A is engaged with a second terminal 220A. As shown in FIGS. 9 and 10, in the present embodiment, the wire-to-board connector assembly 10A also includes a wire-end connector 100 and a board-end connector 200. The difference between assembly 10A and assembly 10 is that a first accommodating channel 111A of a first housing 110A accommodates a first terminal 120A having three wire coupling portions 122A. In the present embodiment, the three wire coupling portions 122A are electrically connected through a first main plate 121A and can each be connected to the wire W to receive electrical current. Since the socket spacing (not shown) for plugging in the pins 222A on the circuit board 300 is fixed, when the width of the first main plate 121A increases, the second main plate 221A engaged with the first main plate 121A will also have a larger cross-sectional area. This larger cross-sectional area allows the second main plate 221A to accommodate a corresponding number of pins 222A and to carry a greater amount of current.

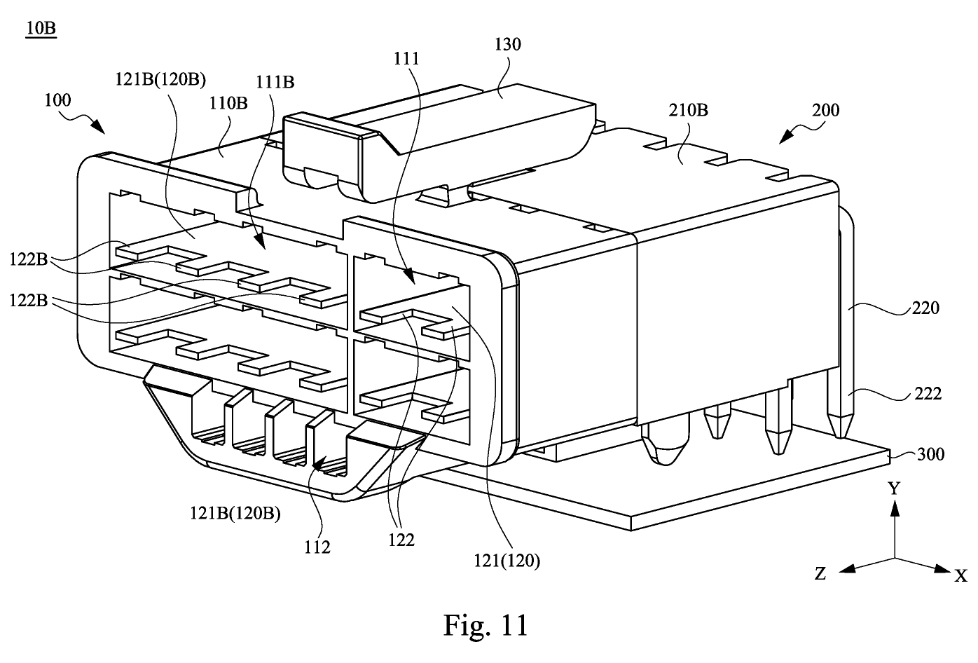

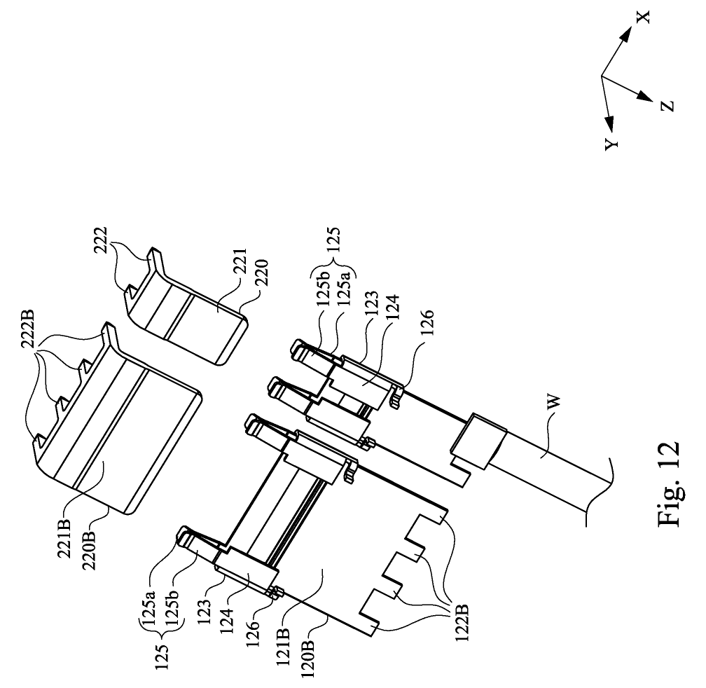

Please refer to FIGS. 11 and 12. FIG. 11 is a perspective view of the wire-to-board connector assembly 10 of FIG. 1 according to another embodiment of the present disclosure. FIG. 12 is a perspective view of a wire-to-board connector assembly 10B of FIG. 11 before a first terminal 120B is engaged with the second terminal 220B. As shown in FIGS. 11 and 12, in the present embodiment, the wire-to-board connector assembly 10B also includes the wire-end connector 100 and a board-end connector 200. The difference between assembly 10B and assembly 10 is that a first accommodating channel 111B of the first housing 110B can accommodate a first terminal 120B having four wire coupling portions 122B, and the first housing 110B can simultaneously include both the first accommodating channel 111B and the first accommodating channel 111. In other words, the wire-end connector 100 of the wire-to-board connector assembly 10B may simultaneously include the first terminals 120 and 120B having different numbers of wire coupling portions 122 and 122B. In the present embodiment, the first accommodating channel 111 and the first terminal 120 have already been described in detail and will not be repeated here. The first main plate 121B has a larger cross-sectional area than the first main plate 121 (for example, it may be twice the size, although the present disclosure is not limited to this ratio), thereby increasing the cross-sectional area to carry a larger current and electrically connect the four wire coupling portions 122B. To correspond to the larger width of the first main plate 121B, the second main plate 221B also has a larger cross-sectional area to carry a greater amount of current and a corresponding number of pins 222B.

As shown in FIGS. 9-12, in the present embodiment, while the two examples illustrate the use of the first main plate 121A to simultaneously electrically connect the first terminal 120A to three wire coupling portions 122A, and the use of the first main plate 121B to simultaneously electrically connect the first terminal 120B to four wire coupling portions 122B, the present disclosure is not limited to these configurations. In some embodiments, the first main plates 121A and 121B of the first terminals 120A and 120B may also simultaneously electrically connect three or more wire coupling portions 122A and 122B. Likewise, the first housings 110A and 110B may simultaneously include first accommodating channels 111A and 111B of different sizes to accommodate first main plates 121A and 121B of different widths.

According to the foregoing recitations of the embodiments of the present disclosure, it can be seen that in the wire-to-board connector assembly, and its wire-end connector and board-end connector, the conductive cross-sectional area of the first terminal can be increased by electrically connecting the plurality of wire coupling portions to the first main plate, thereby allowing the terminal to carry a larger amount of current. By forming the accommodating channels of the first housing and the second housing as rectangular accommodation spaces, the flat first main plate and the flat second main plate can be accommodated, thereby increasing the conductive cross-sectional area and reducing the resistance. In addition, by designing the contact portion, where the first terminal engages with the second terminal, as the clip structure, the terminals can be easily plugged in and unplugged, while preventing loosening or poor contact due to slight gap changes caused by factors such as thermal expansion, vibration, or abrasion during the electrical connection process. This design also enables the contact portion to be compatible with second main plates of different thicknesses or widths.

Although the present invention has been described in considerable detail with reference to certain embodiments, other embodiments are also possible. Accordingly, the spirit and scope of the appended claims should not be limited to the specific embodiments described herein.

It will be apparent to those skilled in the art that various modifications and variations can be made to the structure of the present disclosure without departing from its scope or spirit. In view of the foregoing, it is intended that the present disclosure cover such modifications and variations, provided that they fall within the scope of the following claims.

What is claimed is:

1. A wire-end connector, comprising:
a first housing; and
a first terminal disposed in the first housing, the first terminal comprising a first main plate and a plurality of wire coupling portions connected thereto, the wire coupling portions being configured to connect at least one wire.

2. The wire-end connector of claim 1, wherein the first terminal further comprises a bending portion, an extension portion, and a contact portion, the bending portion is connected to the extension portion, the bending portion bends substantially perpendicularly from two opposite sides of the first main plate, the extension portion extends toward each other substantially parallel to the first main plate, and the contact portion comprising a clip structure.

3. The wire-end connector of claim 1, wherein the first housing further comprises an opening portion and a receiving portion, the opening portion and the receiving portion being connected to each other, the receiving portion having a plurality of connection ports, each of the connection ports comprising two long plates and two short plates, a length of the two long plates being greater than a length of the two short plates, and a length ratio of one of the two long plates to one of the two short plates being greater than 1.5.

4. The wire-end connector of claim 1, wherein the first housing comprises a first accommodating channel, the first terminal being disposed in the first accommodating channel, the first accommodating channel having a cross-sectional profile, and the cross-sectional profile is substantially rectangular.

5. The wire-end connector of claim 4, wherein the first terminal further comprises two engaging elements and a stop pin, the first housing further comprising a stop surface, two sliding grooves, and a stop rib, the two sliding grooves and the stop rib being disposed in the first accommodating channel, the two engaging elements being configured to slide into the two sliding grooves and be clamped on both sides of the stop rib, and the stop pin abutting against the stop surface.

6. A board-end connector configured for use with the wire-end connector of claim 1, comprising:
a second housing; and
a second terminal disposed in the second housing, the second terminal comprising a second main plate and a plurality of pins connected thereto, the pins being configured to plug into a circuit board.

7. The board-end connector of claim 6, wherein the second housing comprises a second accommodating channel, the second terminal being disposed in the second accommodating channel, the second accommodating channel having a cross-sectional profile, the cross-sectional profile being substantially rectangular, and a ratio of length to width of the cross-sectional profile is greater than 1.5.

8. A wire-to-board connector assembly, comprising:
a wire-end connector, comprising:
a first housing; and
a first terminal disposed in the first housing, the first terminal comprising a first main plate and a plurality of wire coupling portions connected thereto, the wire coupling portions being configured to connect at least one wire; and
a board-end connector, comprising:
a second housing detachably connected to the first housing; and
a second terminal disposed in the second housing and engaged with the first terminal, the second terminal comprising a second main plate and a plurality of pins connected thereto, the pins being configured to plug into a circuit board;
wherein the first terminal further comprises a bending portion, an extension portion, a first clip, and a second clip, the bending portion being connected to the extension portion, the bending portion bends substantially perpendicularly from two opposite sides of the first main plate, the extension portion extending substantially parallel to the first main plate and extending toward each other, the first clip extending from the first main plate toward the second terminal, the second clip extending from the extension portion toward the second terminal, and the first clip and the second clip jointly clamping the second main plate of the second terminal.

9. The wire-to-board connector assembly of claim 8, wherein the first housing comprises a first accommodating channel, the first terminal is disposed in the first accommodating channel, the first accommodating channel having a cross-sectional profile, and the cross-sectional profile being substantially rectangular.

10. The wire-to-board connector assembly of claim 8, wherein the second housing comprises a second accommodating channel, the second terminal is disposed in the second accommodating channel, the second accommodating channel having a cross-sectional profile, the cross-sectional profile being substantially rectangular, and a ratio of length to width of the cross-sectional profile of being greater than 1.5.

11. The wire-to-board connector assembly of claim 10, wherein the first housing further comprises an opening portion and a receiving portion, the opening portion and the receiving portion being connected to each other, and the receiving portion being disposed in the second accommodating channel.

12. The wire-to-board connector assembly of claim 11, wherein the receiving portion has a plurality of connection ports, the connection ports each comprising two long plates and two short plates, a length of the two long plates being greater than a length of the two short plates, and a length ratio of one of the two long plates to one of the two short plates being greater than 1.5.

13. The wire-to-board connector assembly of claim 12, wherein the bending portion of the first terminal is adjacent to an inner surface of one of the two short plates of the receiving portion, and the extension portion of the first terminal is adjacent to an inner surface of one of the two long plates of the receiving portion.

14. The wire-to-board connector assembly of claim 8, further comprising a third terminal and a fourth terminal, the third terminal being disposed in the first housing, the fourth terminal being disposed in the second housing, and the third terminal being electrically connected to the fourth terminal.

15. The wire-to-board connector assembly of claim 14, wherein the first housing comprises a third accommodating channel, the second housing comprises a fourth accommodating channel, the third terminal being disposed in the third accommodating channel, the fourth terminal being disposed in the fourth accommodating channel, and the third accommodating channel and the fourth accommodating channel being interconnected.
